(19) United States
(12) Patent Application Publication
(10) Pub. No.: US 2008/0208829 A1
(43) Pub. Date: Aug. 28, 2008

(54) METHOD AND APPARATUS FOR MANAGING FILES AND INFORMATION STORAGE MEDIUM STORING THE FILES

(75) Inventor: Alexander Limonov, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/968,358

(22) Filed: Jan. 2, 2008

(30) Foreign Application Priority Data
Feb. 22, 2007 (KR) 2007-18094

(51) Int. Cl. G06F 17/30

(52) U.S. Cl. 707/4; 707/104.1; 707/200; 707/E17.009; 707/E17.014; 707/E17.044

(57) ABSTRACT

A file management method of efficiently searching for and managing files, and an information storage medium storing the files, the method of searching for a file from an information storage medium storing at least one file including: combining at least one tag item selected or excluded by a user through a graphic user interface to generate a query; searching for tag information included in the at least one file and determining whether one or more files match the query; and, if one or more files match the query, outputting a list of the one or more files. Therefore, a user can easily search for a desired file even when he or she does not know the desired file's path, and can efficiently classify and manage a large number of media files.

### CROSS-REFERENCE TO RELATED APPLICATION

This application claims the benefit of Korean Application No. 2007-18094 filed Feb. 22, 2007 in the Korean Intellectual Property Office, the disclosure of which is incorporated herein by reference.

### BACKGROUND OF THE INVENTION

1. Field of the Invention

Aspects of the present invention relate to a method and apparatus for efficiently searching for and managing files, and an information storage medium storing the files.

2. Description of the Related Art

A media storage unit is an apparatus or software that provides an interface for storing, searching for, and accessing media files so as to manage the media files. A media file can store all forms of images, audio, video, and/or text data. Generally, a file/folder model is widely used to store all types of data. In order to access a file that is stored in a device (such as a PC), a user must browse folders or designate a path of the file using a command prompt or a graphic user interface.

However, in order to designate the path of the file or browse the folders, the user must know the structures of the file and folders. Also, if the file is stored in or moved to an unintended folder by mistake, it is difficult to find the file later. Furthermore, if a large number of media files are stored in a folder, it is difficult to find a desired file.

### SUMMARY OF THE INVENTION

Aspects of the present invention provide a file management method and apparatus to allow a user to easily access his/her desired file although he or she does not know the structures of folders, and an information storage medium thereof.

According to an aspect of the present invention, there is provided an information storage medium for storing at least one file, wherein the at least one file comprises tag information used to access the at least one file, the information storage medium comprising tag structure information into which the tag information included in the at least one file is integrated.

According to an aspect of the present invention, when a new file having tag information which is not included in the tag structure information is stored in the information storage medium, the tag structure information maybe updated according to the tag information of the new file.

According to an aspect of the present invention, the tag structure information is obtained, by arranging tag items that are included in tag information of the at least one file stored in the information storage medium in a tree structure.

According to an aspect of the present invention, the tag structure information is written in Extensible Markup Language (XML).

According to another aspect of the present invention, there is provided a method of searching for a file from an information storage medium storing at least one file, the method including: combining at least one tag item selected or excluded by a user through a graphic user interface, to generate a query; searching for tag information included in the at least one file and determining whether the at least one file matches the query; and if one or more files match the query, outputting a list of the one or more files. According to another aspect of the present invention, there is provided a method of searching for a file from an information storage medium storing at least one file, including: displaying tag structure information into which tag information included in the at least one file stored in the information storage medium is integrated, and receiving a query through a graphic user interface, the graphic user interface including a first area for allowing a user to select or exclude a desired tag item, and a second area for dynamically displaying at least one file matched to a query which is changed according to the selection or exclusion of the desired tag item; searching for the tag information included in the at least one file, and determining whether the at least one file matches the query; and if one or more files match the query, outputting a list of the one or more files.

According to another aspect of the present invention, there is provided a method of storing a file in an information storage medium, the method including: receiving a new file that is to be stored; determining whether tag information included in the new file is a subset of tag structure information into which tag information included in the file stored in the information storage medium is integrated; if the tag information of the new file is not the subset of the tag structure information, updating the tag structure information or the tag information of the new file so that the tag information of the new file becomes the subset of the tag structure information; and storing the new file.

According to an aspect of the present invention, the updating may include, if the tag information of the new file includes a tag item which does not exist in the tag structure information, integrating the tag information of the new file into the tag structure information.

According to an aspect of the present invention, the updating may include, receiving information from a user if no tag information exists in the new file, generating tag information corresponding to the received information with reference to the tag structure information, and then recording the generated tag information in the new file.

According to another aspect of the present invention, there is provided a method of managing one or more file stored in an information storage medium, the method including: if tag structure information, into which tag information included in at least one file stored in the information storage medium is integrated, is changed, determining whether a file including a changed tag item exists; if the file including the changed tag item exists, updating tag information of the file according to the changed tag structure information.

According to another aspect of the present invention, there is provided a file search apparatus including: a storage unit storing at least one file including tag information; and a control unit combining at least one tag item selected or excluded by a user through a graphic user interface, to generate a query, searching for the tag information to determine whether one or more files match the query, and displaying a list of the one or more files on a display unit if the one or more files match the query. According to another aspect of the present invention, there is provided a file search apparatus including: a storage unit storing at least one file including tag information and tag structure information into which the tag information included in the at least one file is integrated; and a control unit displaying the tag structure information into which the tag information included in the at least one file stored in the information storage medium is integrated, receiving a query through a graphic user interface, searching for the tag information to determine whether one or more files matched to the query exist, and outputting a list of the one or more files to a display unit if the one or more files matched to the query exist, wherein the graphic user interface includes a first area for allowing a user to select or exclude a desired tag item, and a second area for dynamically displaying a list of files matched to a query which are changed according to the selection or exclusion of the desired tag item.

According to another aspect of the present invention, there is provided a file storage apparatus including: a file input unit receiving a new file that is to be stored; a storage unit storing at least one file including tag information, and tag structure information into which the tag information included in the at least one file is integrated; and a controller determining whether tag information included in the new file is a subset of the tag structure information stored in the storage unit, updating the tag structure information or the tag information of the new file, if the tag information of the new file is not the subset of the tag structure information, so that the tag information of the new file is the subset of the tag structure information, and storing the new file in the storage unit.

According to another aspect of the present invention, there is provided a file management apparatus including: a storage unit storing at least one file including tag information, and tag structure information into which the tag information included in the at least one file is integrated; and a controller determining whether a file including a changed tag item exists if the tag structure information is changed, and updating tag information of the file including the changed tag item, according to the changed tag structure information, if the file including the changed tag item exists.

Additional aspect and/or advantage of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structure of data that is stored in an information storage medium according to an embodiment of the present invention;

FIG. 2 is a block diagram of an apparatus for searching for, storing, and/or managing files according to an embodiment of the present invention;

FIG. 3 is a flowchart of a file search method according to an embodiment of the present invention;

FIG. 4 illustrates a screen of a graphic user interface according to an embodiment of the present invention;

FIG. 5 illustrates an example of tag structure information illustrated in FIG. 4;

FIG. 6 illustrates an example of tag information of a file that is searched by the graphic user interface illustrated in FIG. 4;

FIG. 7 is a flowchart of a file storing method according to an embodiment of the present invention;

FIG. 8 illustrates an example of a screen through which tag information is recorded in a new file according an embodiment of the present invention;

FIG. 9 illustrates an example of tag information that is input through the screen illustrated in FIG. 8;

FIG. 10 illustrates an example of tag information included in a new file that is to be stored according to an embodiment of the present invention;

FIG. 11 illustrates an example of tag structure information updated after the new file having the tag information illustrated in FIG. 10 is stored; and

FIG. 12 illustrates an example in which two pieces of tag structure information are integrated into a single structure according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

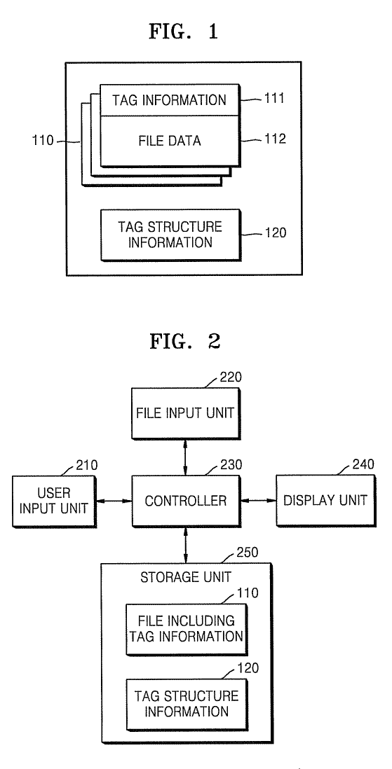

FIG. 1 illustrates the structure of data that is stored in an information storage medium according to an embodiment of the present invention. In the information storage medium, a user accesses a desired file by using a query to search for tag information stored in the desired file instead of designating a path including a file name and a folder. Accordingly, a file system that is used in conventional storage media is modified so that the file system stores tag information instead of folder information. The tag information of a file can be stored in the form of metadata and include at least one tag item. According to the current embodiment, compatibility is ensured because tag information is stored separately in each file. That is, a file including tag information can be transmitted to an apparatus using a conventional file system and a conventional protocol, or can be stored in the apparatus using a file system according to aspects of the present invention.

Referring to FIG. 1, an apparatus for searching for, storing, and/or managing files includes a storage unit that stores a plurality of files 110 and tag structure information 120. Each of the plurality of files 110 includes file data 112 and tag information 111. Furthermore, the tag structure information 120 integrates the tag information 111 of the files 110. That is, the tag information 111 of each file 110 is included in the tag structure information 120. According to aspects of the present invention, the tag structure information 120 may be in the form of a database that arranges all tag items included in the tag information 111 of the files 110 into a hierarchical tree. Here, the respective tag items may have a parent-child relationship. When a new external file having no tag information is stored in the information storage medium, tag information 111 regarding the new file may be generated and recorded with reference to the tag structure information 120. Also, when a new file having tag information 111 that is not included in the tag structure information 120 is stored in the information storage medium, the tag structure information 120 is updated according to the tag information of the new file. Accordingly, the tag structure information 120 is maintained as the most up to date information. The tag information 111 and the tag structure information 120 may be written in the Extensible Markup Language (XML), or recorded in the form of a database; however, aspects of the present invention are not limited thereto.

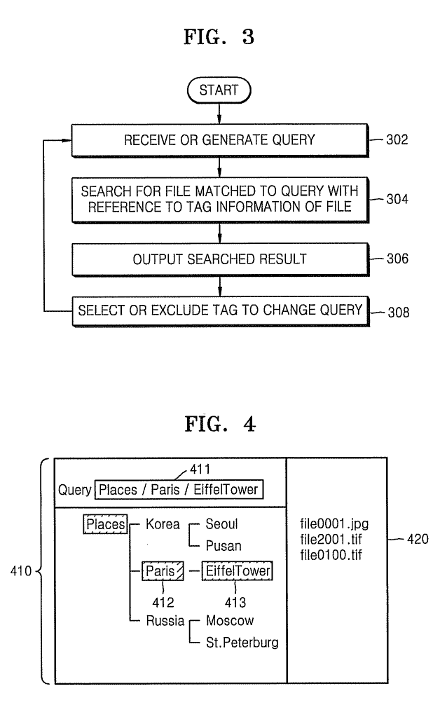

FIG. 2 is a block diagram of an apparatus for searching for, storing, and/or managing files according to an embodiment of the present invention. Referring to FIG. 2, the apparatus includes an input unit 210 to allow a user to input data, a file input unit 220 to receive a file that is to be stored from an external device or an external memory, a display unit 240, a storage unit 250 to store at least one file and tag structure information into which tag information included in each of the files is integrated, and a controller 230 to search for, store, and/or manage the files with reference to the tag information 111 and/or tag structure information 120 stored in the storage unit 250. Detailed descriptions of the respective components will be given later with reference to FIGS. 3 through 12. The apparatus may, although not necessarily, be a computer, a server, a mobile device, or a portable multimedia player.

FIG. 3 is a flowchart of a file search method according to an embodiment of the present invention. Referring to FIG. 3, a query is received or generated in operation 302. The query indicates a file search condition. The query may be input as a command prompt by a user, or generated by a file search apparatus that combines tag items selected by the user through a graphic user interface. In the case where a query is input as a command prompt by a user, the query may be a query including a general binary operation (such as AND/OR/NOT) and tag items. For example, if tag items A, B, and C exist, a query “A/B/C” is the search condition “A AND B AND C,” a query “A/B/-C” is the search condition “A AND B AND NOT C,” and a query “A|B/C” is the search condition “A OR B AND C”. However, these syntaxes are only examples, and different syntaxes may be used according to other aspects. Meanwhile, in the case where a query is generated by a file search apparatus that combines tag items selected by a user through a graphic user interface, the graphic user interface may be able to dynamically change a search condition and/or search result according to the selection and/or the exclusion of tag items by the user. Furthermore, it is understood that other search styles, such as natural language searches, can be done.

FIG. 4 illustrates a screen of a graphic user interface according to an embodiment of the present invention. Referring to FIGS. 2 and 4, the graphic user interface includes a first area 410 that displays tag structure information 120 into which tag information 111 included in at least one file stored in the storage unit 250 is integrated, and allows a user to select or exclude a desired tag. The graphic user interface further includes a second area 420 that dynamically displays a list of files that are matched to a query that is changed according to the user's tag selection or exclusion. The user can manipulate the query (by, for example, selecting, canceling, and/or excluding a specific tag item) by using the tag structure information of the first area 410. The graphic user interface further includes a query area 411 that displays a query generated as a result of the manipulation or allows the user to directly input a query. It is understood that, according to other aspects, the graphic user interface may not include the first area 410 that allows a user to select or exclude a desired tag. That is, according to other aspects, the graphic user interface may only allow the user to enter the query as a command prompt in the query area 411.

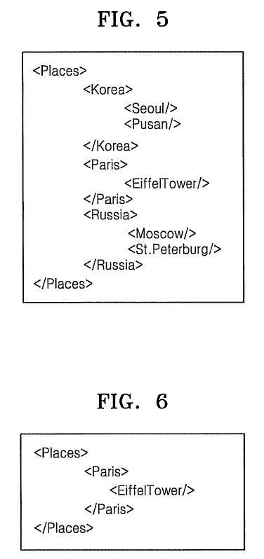

When the graphic user interface is initially executed, the controller 230 reads and interprets the tag structure information 120 of the storage unit 250, outputs the result of interpretation to the first area 410, and displays the query area 411 as empty (until a query is entered). FIG. 5 illustrates an example of tag structure information that is displayed in the first area 410 illustrated in FIG. 4. Meanwhile, the second area 420 outputs a list of all files stored in the storage unit 250. A user can browse tag structure information through the graphic user interface, and can hide or expand tag items that are hierarchically configured, like a folder search in PCs.

Returning to FIG. 3, in operation 304, the controller 230 (illustrated in FIG. 2) searches for files matched to the input or generated query (operation 302) with reference to the tag information of the files. Then, in operation 306, the result of the search is output. The result of the search may be a list of searched files. In the example illustrated in FIG. 4, if a user selects a specific tag, a query including the selected tag is generated and displayed in the query area 411, and a list of files matched to the generated query is displayed in the second area 420. For example, if tag items “Paris” 412 and “EiffelTower” 413 are selected, the route tag item, “Places,” is automatically included to the selection. Accordingly, a query “Places/Paris/EffelTower” is generated (operation 302 in FIG. 3). Then, files which are matched to a search condition “Places AND Paris AND EiffelTower” corresponding to the query “Places/Paris/EffelTower” are searched for (operation 304 in FIG. 3). FIG. 6 illustrates an example of tag information of the files which are searched for in the example illustrated in FIG. 4. As illustrated in FIG. 6, the tag information includes tag items indicated by the query. That is, all three of the searched for files (illustrated in the second area 420 of FIG. 4) include the tag information of FIG. 6 as a subset. In another example (not shown), if a user selects a tag item “Korea” and excludes a tag item “Seoul” in the example illustrated in FIG. 4, a query “Places/Korea/-Seoul” is generated (operation 302 in FIG. 3). As a result, files matched to the corresponding search condition “Places AND Korea AND NOT Seoul” are searched for (operation 304 in FIG. 3).

According to a conventional technique, in order to access a desired file “EiffelTower.jpg,” a file path (for example, “C:/Myphoto/Paris/EiffelTower.jpg”) must be designated. However, when the graphic user interface according to aspects of the present invention (such as is illustrated in FIG. 4) is used, a desired file can be searched for by inputting or selecting only a tag item “EiffelTower,” or by using a query “Places/Paris/EiffelTower” or “Paris/EiffelTower.” The tag items may be included in the query in any order. That is, a query “Paris/EiffelTower” and a query “EiffelTower/Paris” will display the same search result. Also, according to aspects of the present invention, if a variety of types of media files are stored in the storage unit 250 (illustrated in FIG. 2), the types of files that are to be searched for can be designated using a query (such as “Photo/Paris/EiffelTower,” “Paris/EiffelTower/Photo,” “EiffelTower/Photo,” etc.). The controller 230 can recognize the types of files by referring to the extensions of the files in order to search for only a user's desired types of files. Alternatively, the controller 230 can add tag items indicating the types of files to the tag structure information 120 (illustrated in FIG. 1), and search for desired files using the tag items. Accordingly, according to aspects of the present invention, although all files may be stored in a single folder, a user can easily search for desired files by simple keyboard input manipulation.

Again returning to FIG. 3, in operation 308, when a user additionally selects and/or excludes a desired tag item or cancels a selected tag while the result of the search is displayed, the query is changed according to the user's manipulation and a search operation is again executed according to the changed query. Accordingly, the result of the searching is updated according to the changed query. For example, referring to FIG. 4, if the tag item “Korea” is selected, files whose tag information includes “Places/Korea” are searched for and output in the second area 420. If a tag item “Seoul” is additionally selected, files whose tag information includes “Places/Korea/Seoul” are searched for and output in the second area 420. If the tag item “Seoul” is cancelled, all files whose tag information includes “Places/Korea” are again output in the second area 420. Also, according to aspects of the present invention, once a query has been entered, the query is added as a bookmark so that the query can be used later for a quick file search.

In the case of the conventional technique of designating a file path to access a file, it is necessary to change the names of picture files that have been photographed, for example, at the Eiffel Tower to identifiable names (such as EiffelTower1.jpg, EiffelTower2.jpg, EiffelTower3.jpg, etc.), and to store the picture files as the identifiable names in the corresponding folder. In the conventional technique, a path (such as “C:/Myphoto/Paris/EiffelTower1.jpg”) must be designated in order to access the corresponding file. However, according to aspects of the present invention, if a user inputs only tag information “EiffelTower,” tag information as illustrated in FIG. 6 can be collectively recorded. This is because parent tag items of “EiffelTower” can be searched for with reference to the tag structure information illustrated in FIG. 5. If the corresponding file includes tag information “Places/Paris” in advance, only a tag item “EiffelTower” will be added as a child tag item of “Paris.”

A case where a user manages picture files stored in the information storage medium will now be described in detail. It is assumed that a query “Photo/-Places” is generated to search for files having no tag item indicating a place. If one or more files of the searched for files are selected and a tag item “Seoul” is added to the selected files by a user, tag information including all parent tag items corresponding to the tag item “Seoul” as well as the tag item “Seoul” is generated. Then, the generated tag information is added to the selected files. By adding the tag information to the files, the files to which the tag information is added will disappear from the second area 420 (illustrated in FIG. 4). This is because the current query is “Photo/-Places.” Accordingly, when tag items indicating a place are added to all the files searched for by the query “Photo/-Places,” no file will be found by the query because all of the “Photo” files (files with a parent tag of “Photo”) will have a tag item indicating a place (in this case, “Seoul”).

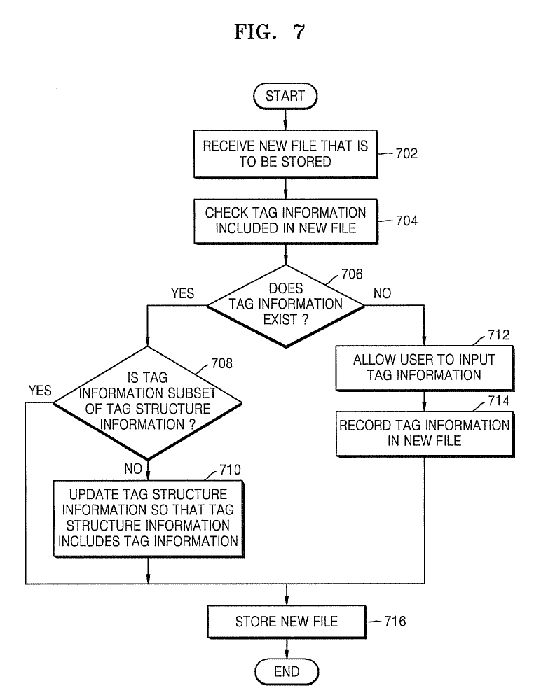

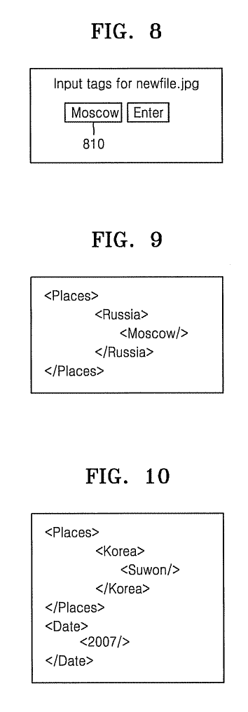

FIG. 7 is a flowchart of a file storage method according to an embodiment of the present invention. Referring to FIGS. 2 and 7, a new file that is to be stored is received by the file input unit 220 in operation 702. In operations 704 and 706, the controller 230 determines whether tag information 111 exists in the new file. If no tag information 111 exists in the new file (operation 706), the controller 230 allows a user to input tag information 111 in operation 712. If the user inputs tag information 111 (operation 712), the tag information 111 is written in the file in operation 714. At this time, the user does not need to input all tag information. If the user inputs only a part of the tag information 111, the controller 230 can generate complete tag information 111 with reference to the tag structure information 120 (illustrated in FIG. 1). For example, if tag items included in the tag information inputted for the new file already exist in the tag structure information 120, then the controller 230 can refer to the relationships between tag items in the tag structure information 120 (such as that between a parent tag item and a child tag item) to discern the complete tag information 111. FIG. 8 illustrates a screen for allowing a user to input tag information to a new file “newfile.jpg” according to an embodiment of the present invention. Referring to FIG. 8, if the user inputs a tag item “Moscow” to an input blank 810 on the screen, the controller 230 acquires parent tag items of the tag item “Moscow” with reference to the tag structure information as illustrated in FIG. 5. Then, the controller 230 generates tag information for the file “newfile.jpg” and records the tag information in the file “newfile.jpg.” FIG. 9 is an example of tag information generated when the user inputs the tag item “Moscow.” It is understood that, according to other aspects, instead of inputting tag information before storing a new file, the user can input or correct tag information by using a file management screen after the file has been stored.

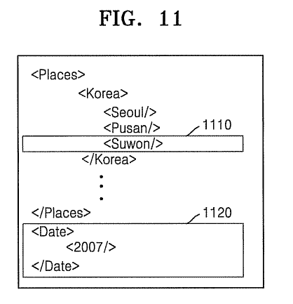

Returning to FIGS. 2 and 7, if tag information 111 exists in the new file (operation 706), the tag structure information 120 (illustrated in FIG. 1) is read and compared with the tag information 111 of the new file. Then, in operation 708, it is determined whether the tag information 111 of the new file is a subset of the tag structure information 120. If the tag information 111 of the new file is a subset of the tag structure information 120 (i.e., if tag items included in the tag information 111 of the new file and the relationship between the tag items are identical to those included in the tag structure information 120), the new file is stored in operation 716. However, in operation 710, if tag items included in the tag information 111 of the new file and the relationship between the tag items are not included in the tag structure information 120 (operation 708), the tag structure information 120 is updated before the new file is stored. FIG. 10 is an example of tag information 111 included in a new file that is to be stored according to an embodiment of the present invention. If the tag structure information 120 is stored as illustrated in FIG. 5 and tag items corresponding to tag items “Suwon” and “Data/2007” are not included in the tag structure information 120, the tag structure information 120 is updated as illustrated in FIG. 11. That is, a part 1110 corresponding to “Suwon” and a part 1120 corresponding to “Date/2007” are added to the tag structure information 120. In this way, even when no tag structure information exists, tag structure information can be generated and updated automatically by storing a new file.

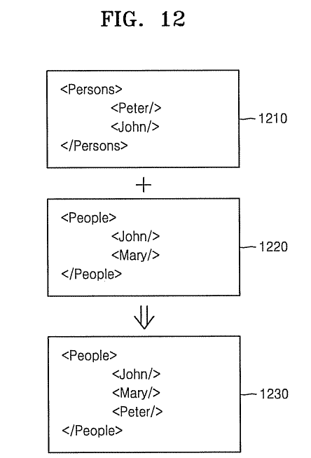

FIG. 12 illustrates an example in which two pieces of tag structure information are integrated into single tag structure information according to an embodiment of the present invention. Referring to FIG. 12, it is seen that tag structure information 1210 having lowest tag items “Peter” and “John” and tag structure information 1220 having lowest tag items “John” and “Mary” are integrated into a single tag structure information 1230. In this example, the integrated tag structure information 1230 is generated while a tag item “Persons” changes to a tag item “People”.

Referring to FIG. 2, a user can inquire about tag structure information 120, change the names of tag items included in the tag structure information 120, rearrange and erase the tag items, add different tag items to the tag structure information 120, and integrate a plurality of tag structure information into a single tag structure information as described above with reference to FIG. 12. Also, referring to FIG. 1, tag information 111 included in each file 110 will also be updated according to the changed tag structure information 120. In detail, if tag structure information 120 having tag information included in at least one file stored in the storage unit 250 is changed, the controller 230 determines whether a file including at least one changed tag item exists, and updates tag information of the corresponding file according to the changed tag structure information.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, optical data storage devices, and a computer data signal embodied in a carrier wave comprising a compression source code segment comprising the code and an encryption source code segment comprising the code (such as data transmission through the Internet). The computer-readable recording medium can also be distributed over network-coupled computer systems so that the computer-readable code is stored and executed in a distributed fashion.

As described above, according to aspects of the present invention, a user can easily search for a desired file even when he or she does not know the desired file's path, and can efficiently classify and manage a large number of media files.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information storage medium for storing at least one file, wherein the at least one file comprises tag information used to access the at least one file, the information storage medium comprising tag structure information into which the tag information included in the at least one file is integrated.

2. The information storage medium as claimed in claim 1, wherein, when a new file is stored in the information storage medium, tag information is recorded in the new file with reference to the tag structure information.

3. The information storage medium as claimed in claim 1, wherein, when a new file having tag information that is not included in the tag structure information is stored in the information storage medium, the tag structure information is updated according to the tag information of the new file.

4. The information storage medium as claimed in claim 1, wherein the tag structure information is obtained, by arranging tag items which are included in tag information of the at least one file stored in the information storage medium, in a tree structure.

5. The information storage medium of claim 1, wherein the tag structure information is written in Extensible Markup Language (XML).

6. A method of searching for a file from an information storage medium storing at least one file, the method comprising:
combining at least one tag item selected or excluded by a user through a graphic user interface, to generate a query;
searching for tag information included in the at least one file and determining whether the at least one file matches the query; and
if one or more files match the query, outputting a list of the one or more files.

7. A method of searching for a file from an information storage medium storing at least one file, the method comprising:
Displaying tag structure information into which tag information included in the at least one file stored in the information storage medium is integrated, and receiving a query through a graphic user interface, the graphic user interface including a first area for allowing a user to select or exclude a desired tag item, and a second area for dynamically displaying at least one file matched to a query which is changed according to the selection or exclusion of the desired tag item;
searching for the tag information included in the at least one file, and determining whether the at least one file matches the query; and
if one or more files match the query, outputting a list of the one or more files.

8. A method of storing a file in an information storage medium, the method comprising:
receiving a new file that is to be stored;
determining whether tag information included in the new file is a subset of tag structure information into which tag information included in the file stored in the information storage medium is integrated;
if the tag information of the new file is not a subset of the tag structure information, updating the tag structure information or the tag information of the new file so that the tag information of the new file becomes the subset of the tag structure information; and
storing the new file.

9. The method as claimed in claim 8, wherein the updating comprises, if the tag information of the new file includes a tag item which does not exist in the tag structure information, integrating the tag information of the new file into the tag structure information.

10. The method as claimed in claim 8, wherein the updating comprises:
receiving information from a user if the tag information is not included in the new file;
generating tag information corresponding to the received information with reference to the tag structure information; and
recording the generated tag information in the new file.

11. A method of managing one or more files stored in an information storage medium, the method comprising:
If tag structure information, into which tag information included in at least one file stored in the information storage medium is integrated, is changed, determining whether a file including a changed tag item exists;
if the file including the changed tag item exists, updating tag information of the file according to the changed tag structure information.

12. A file search apparatus comprising:
a storage unit to store at least one file including tag information; and
a control unit to combine at least one tag item selected or excluded by a user through a graphic user interface, to generate a query, searching for the tag information to determine whether one or more files match the query, and displaying a list of the one or more files on a display unit if the one or more files match the query.

13. A file search apparatus comprising:
a storage unit to store at least one file including tag information and tag structure information into which the tag information included in the at least one file is integrated; and
a control unit to display the tag structure information into which the tag information included in the at least one file stored in the information storage medium is integrated, receiving a query through a graphic user interface, searching for the tag information to determine whether one or more files matched to the query exist, and outputting a list of the one or more files to a display unit if the one or more files matched to the query exist, wherein the graphic user interface includes a first area for allowing a user to select or exclude a desired tag item, and a second area for dynamically displaying a list of files matched to a query which are changed according to the selection or exclusion of the desired tag item.

14. A file storage apparatus comprising:
a file input unit to receive a new file that is to be stored;
a storage unit to store at least one file including tag information, and tag structure information into which the tag information included in the at least one file is integrated; and
a controller to determine whether tag information included in the new file is a subset of the tag structure information stored in the storage unit, updating the tag structure information or the tag information of the new file, if the tag information of the new file is not the subset of the tag structure information, so that the tag information of the new file is the subset of the tag structure information, and storing the new file in the storage unit.

15. The file storage apparatus as claimed in claim 14, wherein, if the tag information of the new file includes a tag item which does not exist in the tag structure information, the controller integrates the tag information of the new file into the tag structure information.

16. The file storage apparatus as claimed in claim 14, wherein, if no tag information exists in the new file, the controller receives information from a user, generates tag information corresponding to the received information with reference to the tag structure information, and records the generated tag information in the new file.

17. A file management apparatus comprising:
a storage unit to store at least one file including tag information, and tag structure information into which the tag information included in the at least one file is integrated; and
a controller to determine whether a file including a changed tag item exists if the tag structure information is changed, and updating tag information of the file including the changed tag item, according to the changed tag structure information, if the file including the changed tag item exists.

18. A computer-readable recording medium having embodied thereon a program for executing the method of claim 6.

19. A computer-readable recording medium having embodied thereon a program for executing the method of claim 7.

20. A computer-readable recording medium having embodied thereon a program for executing the method of claim 8.

21. A computer-readable recording medium having embodied thereon a program for executing the method of claim 11.
